(19) United States
(12) Patent Application Publication
(10) Pub. No.: US 2025/0334488 A1
(43) Pub. Date: Oct. 30, 2025

(54) COLLECTOR FOR COLLECTING A LIQUID SAMPLE

(71) Applicant: Zhejiang Orient Gene Biotech Co.,Ltd, Huzhou (CN)

(72) Inventors: Lili SHEN, Huzhou (CN); Jianqiu FANG, Huzhou (CN)

(21) Appl. No.: 18/667,741

(22) Filed: May 17, 2024

(30) Foreign Application Priority Data
Apr. 28, 2024 (CN) 202410524280X

(51) Int. Cl. G01N 1/10

(52) U.S. Cl. CPC G01N 1/10; G01N 2001/1056

(57) ABSTRACT

The invention discloses a collector for a liquid sample, where the collector includes an absorption element for absorbing the liquid sample; and a fixed tray for fixing the absorption element, where the fixed tray is connected with a rod including a channel, the channel is used for accommodating an indicator strip that indicates presence or absence of a sufficient liquid or a testing element for testing an analyte in the liquid sample, the channel includes an outlet, and the outlet is in fluid communication with the fixed tray.

### BACKGROUND OF THE INVENTION

### Field of the Invention

The invention belongs to the field of in vitro diagnosis and is used for testing an analyte in a liquid sample, and specifically provides a collector for collecting the liquid sample.

### Description of the Related Art

In the detection field, a testing device is a common medical testing instrument, which is mostly used to detect test samples in stored liquids, such as urine, blood, sewage, semi-solid substances (which refers to liquid samples converted by any suitable method), and the like. A common testing tool for testing a liquid sample is a reagent strip. Usually, there are two ways for the reagent strip to obtain the liquid sample. One way is to put the reagent strip directly into the liquid sample, and in this case, the bottom of the reagent strip is in contact with the liquid sample, such that the reagent strip can obtain the liquid sample; the other way is a dropping method, that is, the liquid sample is absorbed by a dropper and other tools and then dropped to the reagent strip, such that the reagent strip can obtain the liquid sample. In these two common ways, the reagent strip is in local contact with the liquid sample; usually, it can only be tested for one item. When the test item is changed, it is necessary to change a different reagent strip.

In the detection field, a collector for collecting liquids is often used, such as cotton swabs, flocked swabs to absorb the liquids, and common sponge polyester that absorbs the liquids and then is compressed to release them; and the sponge polyester is often used especially in saliva collection. A conventional saliva collector is usually bonded to an absorption tray through the adhesive, but the gluing process is complicated, and the adhesive contains harmful substances and causes damage to the environment or the human body; in addition, sometimes the use of an environmentally-friendly and harmless adhesive causes some other processes due to the complicated gluing process, such that the adhesive has a difficulty in mass production.

Therefore, it is necessary to improve the structure of the conventional collector so as not to affect auxiliary functional structures when the adhesive is used.

### BRIEF SUMMARY OF THE INVENTION

In order to overcome the disadvantages of the prior art, the invention provides a collector for collecting a liquid sample, and the collector includes an absorption element for absorbing the liquid sample; and a fixing element for allowing the liquid sample to be stored on the absorption element, where the fixing element is used for fixing the absorption element thereon.

In some embodiments, the absorption element can be provided in one, and includes a first end and a second end that are connected together. In some embodiments, the fixing element is a non-absorbent material. In some embodiments, the fixing element is of a sheet structure or a segmented structure with a recess, and one end of the absorption element is fixed onto the sheet structure.

In some embodiments, an elastic sheet with an opening or a through hole is provided in the recess of the fixing element. In some embodiments, a rod-shaped structure is further provided and connected with the fixing element, where the rod-shaped structure includes a channel, and an outlet of the channel is the same as an opening in the elastic sheet. In some embodiments, the channel is used for accommodating an indicator strip that indicates present or absence of a sufficient liquid. Of course, a test strip can also be provided in the channel, and the indicator strip or the test strip is in contact with the absorption element.

In some embodiments, an adhesive layer is further provided between the elastic sheet and the absorption element, and the absorption element is bonded to the elastic sheet by the adhesive layer. In some embodiments, the fixing element allows the absorption element to be bonded thereon by the adhesive. If the elastic sheet is surrounded by the fixing element, the absorption element is fixed by the adhesive applied onto the elastic sheet and the fixing element.

In some embodiments, the opening in the elastic sheet extends outward to form a protrusion that is similar to one channel, and one end of the indicator strip or test strip extends out of the channel, and there is an adhesive layer around the channel, and the absorption element and the fixing element are bonded together by the adhesive layer. The channel with the protrusion prevents the adhesive from being applied into the channel during adhesive application, which avoids adhesive leakage. In addition, if the adhesive is applied into the channel, the indicator strip cannot be inserted into the channel in an insertion process thereof.

In some embodiments, the absorption element is a polyester foam; the dry polyester foam is rigid and cannot be compressed; however, the polyester foam absorbing liquid can be compressed. In some embodiments, the absorption element is a sponge or a melamine foam, and can be compressed regardless of being dry or wet; alternatively, the absorption element is made of a flexible compressible material.

In some embodiments, the fixing element includes a chamber with an opening and a bottom; the bottom is connected with the rod-shaped structure, and the chamber is configured to accommodate a part of the absorption element and an elastic fixing element; the elastic fixing element is located between the chamber wall and the absorption element and compressed; and the absorption element is fixed into the chamber through a rebound force of the elastic fixing element.

In some embodiments, the elastic fixing element is provided in two; these two elastic fixing elements are located on both sides of the absorption element, and the absorption element is fixed into the chamber through the rebound forces of the two elastic fixing elements. In some embodiments, the absorption element is a cylinder, the elastic fixing element is annular, and the annular elastic fixing element surrounds an outer surface of the cylinder to fix the absorption element onto the chamber.

In some embodiment, the bottom of the chamber has an opening that is the same as a channel in a tubular structure, such that the indicator strip or testing element can be inserted through the opening, and the indicator element or the testing element is in contact with the absorption element. When the absorption element is used for collecting the liquid sample and absorbing the sufficient liquid sample, the liquid sample also flows into the indicator strip, indicating that the collected liquid sample is sufficient. If the liquid sample flows into the test strip, the properties of the liquid sample or the analyte can be assayed.

### BRIEF DESCRIPTION OF THE DRAWINGS

FIG. 1 is a schematic diagram of a conventional collector (prior art).

FIG. 2 is a schematic structural diagram of a collector according to a specific embodiment of the invention.

FIG. 3 is a schematic diagram showing a longitudinal cross-section structure of a collector according to a specific embodiment of the invention.

FIG. 4 is a schematic diagram showing an exploded three-dimensional structure of a collector according to a specific embodiment of the invention.

FIG. 5 is an exploded schematic diagram of a three-dimensional structure of a collector according to a specific embodiment of the invention.

FIG. 6 is a schematic diagram showing a longitudinal cross-section structure of a collector according to a specific embodiment of the invention.

FIG. 7 is a schematic diagram showing a three-dimensional structure of a collector according to a specific embodiment of the invention.

FIG. 8 is a schematic diagram showing a longitudinal cross-section structure of a collector according to a specific embodiment of the invention.

FIG. 9 is a schematic diagram showing an exploded structure of a collector according to a specific embodiment of the invention.

FIG. 10 is a cross-section diagram showing a partial structure (schematic diagram) of a collector according to a specific embodiment of the invention.

FIG. 11 is a schematic diagram showing fixing of an absorption element in a collector according to a specific embodiment of the invention.

FIG. 12 is a schematic diagram showing fixing of an absorption element in a collector according to a specific embodiment of the invention.

### DETAILED DESCRIPTION OF THE INVENTION

### Detection

Detection means to assay or detect presence or absence of a substance or material, including but not limited to, a chemical substance, an organic compound, an inorganic compound, a metabolite, a drug, a drug metabolite, an organic tissue, a metabolite of an organic tissue, a nucleic acid, a protein or a polymer. In addition, detection means that the amount of a substance or material is tested. Further, assay also means immunoassay, chemical assay, enzyme assay, and the like.

### Samples

Samples that can be tested by the testing device of the invention include biological liquids (for example, case liquids or clinical samples). Liquid samples or liquid specimens may be derived from solid or semi-solid samples, including feces, biological tissues and food samples. The solid or semi-solid specimens may be converted to liquid specimens by any appropriate methods, such as mixing, mashing, macerating, incubating, dissolving, or digesting the solid specimens by enzymolysis in suitable solutions, such as water, phosphate solutions, or other buffer solutions. “Biological samples” include animal, plant, and food derived samples, including, for example, human or animal derived urine, saliva, blood and components thereof, spinal fluid, vaginal secretions, sperm, feces, sweat, secretions, tissues, organs, tumors, cultures of tissues and organs, cell cultures, and media. Preferably, the biological sample is urine; and preferably, the biological sample is saliva, sputum, nasal secretion, or the like. Food samples include food processing substances, final products, meat, cheese, wine, milk, and drinking water. Plant specimens include specimens derived from any plants, plant tissues, plant cell cultures, and media. “Environmental specimens” include specimens derived from the environment (for example, liquid specimens from lakes or other bodies of water, sewage specimens, soil specimens, groundwater, seawater, and waste liquid specimens). The environmental specimens may further include sewage or other waste water.

In some embodiment, the sample of the invention may be a urine sample of human or mammal, a saliva sample, a sputum sample or a liquid sample secreted by a nasal cavity.

### Downstream and Upstream

Downstream or upstream is divided according to a flow direction of a liquid. Generally, a liquid flows to a downstream area from an upstream area. The downstream area receives the liquid from the upstream area, and a liquid also may flow to the downstream area along the upstream area. Here, downstream or upstream is generally divided according to a flow direction of a liquid, for example, on some materials where capillary force is utilized to promote the flow of a liquid, a liquid may overcome gravity to flow towards an opposite direction to the gravity; and in this case, downstream or upstream is divided according to a flow direction of the liquid. For example, in the collector of the invention, in some preferred embodiments, the absorption element is used for absorbing the liquid sample, and the indicator strip connected with an end of the absorption element is also used for absorbing the liquid from the absorption element, and when the absorption element absorbs the sufficient liquid sample, the indicator strip has a color to indicate the sufficient liquid sample. The flow of the liquid depends on capillary action and can also flow in an opposite direction to the gravity.

### Gas Communication or Liquid Communication

Gas communication or liquid communication means that liquid or gas can flow from one place to another. In the flow process, the liquid or gas may pass through some physical structures that play a guiding role. The “pass through some physical structures” here means that the liquid passes through the surface of these physical structures or the internal space of these physical structures and flows to another place passively or actively, where the passive flow is usually caused by external forces, such as the flow under the capillary action. The flow here may also be a flow due to self-action (gravity or pressure) of the liquid or gas, and also may be a passive flow.

### Detachable Combination

A detachable combination means that two components are connected in several different states or positional relationships. For example, with two components being physical components, they can be separated at the beginning and then connected or combined in an appropriate first case, and separated in an appropriate second case. Physically, such separation is spatial separation without contact. Alternatively, the two components are combined at the beginning, and can be physically separated from each other when appropriate. In short, combination or separation of two components or two objects can be easily made and repeated many times. Of course, the combination or separation can also be single-use. In addition, such combination can be a detachable combination between two components, or a two-by-two detachable combination between three or more components. For example, a first component, a second component, and a third component are provided, where a detachable combination is made between the first component and the second component or between the second component and the third component. For example, a detachable combination is made between the elastic sheet 203 and the fixed tray, and of course, the elastic sheet cannot be disassembled from the fixed tray after assembly; a detachable combination is made between elastic fixing elements 801, 802, 901, 902 and a chamber of the fixed tray, and the elastic fixing elements can be detached from the chamber of the fixed tray after assembly.

### Testing Element

The testing element can be a lateral flow test strip that can detect a variety of analytes. Of course, other appropriate testing elements also can be used in the invention, and an element that can be used to detect whether a sample or a specimen contains an interested analyte may be called as the testing element. Such testing can be based on any technical principles, such as immunology, chemistry, electricity, optics, and physics. Various testing elements can be combined for use in the invention.| One form of the testing elements is a test strip.

Test strips used in the invention may be commonly referred as lateral flow test strips. The specific structure and testing principle of the test strips are well known to a person skilled in the art in the prior art. A common test strip includes a sample collection area or a sample application area, a label area, a testing area and a water absorption area. The sample collection area includes a sample receiving pad, the label area includes a label pad, and the water absorption area may include a water absorbent pad. The testing area includes necessary chemical substances for detecting the presence or absence of the analyte, such as immunoreagents or enzyme chemical reagents. The nitrocellulose membrane test strip is commonly used, that is, the testing area includes a nitrocellulose membrane, and a specific binding molecule is immobilized on the nitrocellulose membrane to display the testing result; and other test strips such as cellulose acetate membrane or nylon membrane test strips may also be used. Of course, in the downstream of the testing area, there may also be a testing result control area. Generally, the control area and the testing area in the form of horizontal lines, namely, a test line or a control line. Such test strips are conventional. Of course, they may also be other types of test strips for detection under the capillary action. In addition, there are dry chemical reagent components on common test strips, for example, an immobilized antibody or other reagents. When the test strip contacts a liquid, the liquid flows along the test strip under the capillary action, and the dry reagent components are dissolved in the liquid and treated in a next area, and the dry reagents react in the area for necessary detection. The liquid flow mainly relies on the capillary action. An appropriate testing element according to the invention can be used to test any analyte. Preferably, the testing device of the invention is used to detect small drug molecules in saliva and urine. Of course, any samples of the above forms may be collected by a collector according to the invention; regardless of being solid or liquid at the beginning, testing can be performed, provided that these liquids or liquid samples flow to the absorption element and then flow from one end of the absorption element to the testing element.

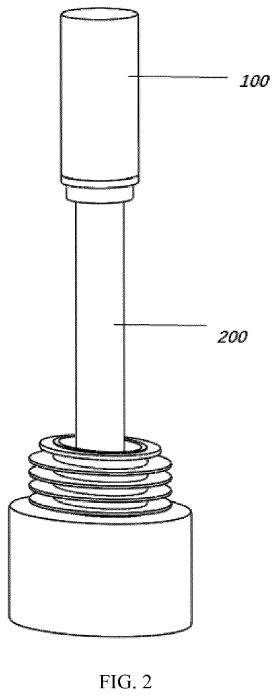

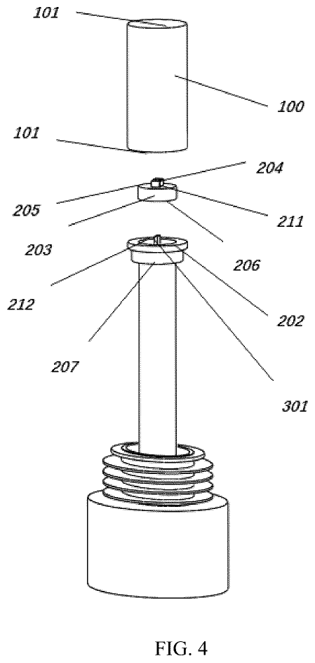

In some embodiments, as shown in FIG. 2-FIG. 9, a hollow chamber 201 can be provided in the rod-shaped body 200 of the collector; the testing element of the invention is provided in the chamber; the testing element includes a testing area; and one end of the testing element is in contact with the end 102 of the absorption element 100. When the absorption element 100 absorbs the sufficient liquid, the excess liquid will be absorbed by the testing element 300; and an analyte in the liquid sample, if any, can be tested in the testing area to obtain the testing results. In some embodiments, the water absorption capacity of the absorption element is less than that of the testing element. The water absorption capacity here means the magnitude of the capillary force rather than an amount of liquid absorbed. If the capillary force of the absorption element is smaller than that of the testing element, the testing element in contact with the absorption element has greater traction for the liquid, thereby accelerating the flow of the liquid on the absorption element and quickly filling the absorption element; moreover, the excess liquid, if any, can flow from one end of the absorption element to the other end thereof along the test strip. If there is a color change in the testing area, the analyte can be tested and the liquid absorbed by the absorption element reaches the maximum saturated absorption capacity. In some embodiments, the testing area includes a testing line (T) and a testing result control line (C). Regardless of the presence or absence of the analyte, the absorption element 100 reaches the saturated absorption capacity with the sufficient liquid sample collected, provided that lines are present in the line C. In some embodiments, the testing area of the testing element and a part where the testing result control area faces the rod-shaped structure 200 are transparent, and the color changes in the testing area and the testing result control area can be observed. In some embodiments, an end portion of a sample application area of the testing element is in contact with one end 102 of the absorption element 100, without being inserted into the absorption element 100, such that all parts of the absorption element can be filled with the liquid sample.

### Indicator Element

Herein, the indicator element is also made of absorbent materials. One end of the indicator element is in contact with the absorption element 100. When the absorption element absorbs the liquid, the liquid always flows from one end 101 of the absorption element to the other end 102 thereof. The excess sample, if any, will flow to the indicator element. The indicator element indicates that the sufficient liquid sample has been collected or that the absorption element has reached the saturated absorption capacity. In some embodiment, an indication area is provided in the indicator strip in which a color pigment is treated, and the color pigment is covered and cannot be seen by naked eyes. After the liquid flows through the indication area, the liquid drives the color pigment to flow together out of a coverage area, such that it can be observed by the naked eyes that color appears on the indicator element, indicating that the absorption element absorbs the sufficient liquid. Of course, there are also colorless chemical reagents that can be treated on the indicator strip; when encountering the liquid sample, the colorless chemical reagents will show colored substances, for example, they interact with some substances in the liquid sample or the properties (PH value) of the liquid sample to show color. The indication area herein can be used to only judge whether the absorption element 100 collects the sufficient liquid sample, instead of being used to test the analyte in the liquid sample. When the liquid can automatically flow from the end 101 of the absorption element to the other end 102 of the absorption element, this means that the absorption element is fully filled with the liquid sample. If there is the excess liquid sample that can flow to the indicator element of the chamber 201 of the rod, this can mean that the absorption element 100 has absorbed the sufficient liquid or the absorption element has reached the maximum saturated absorption capacity. The sufficient liquid sample or the maximum saturated absorption capacity of the absorption element herein can be 50 microliters to 5 milliliters, such as 100 microliters, 200 microliters, 300 microliters, 400 microliters, 500 microliters, 600 microliters, 700 microliters, 800 microliters, 1000 microliters, 1500 microliters, 2000 microliters, 2500 microliters, and 3000 microliters.

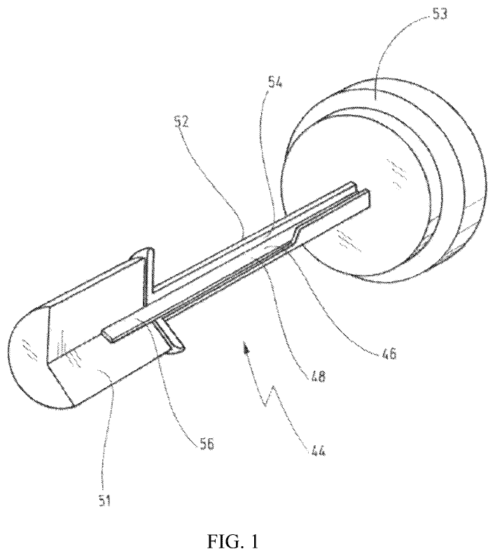

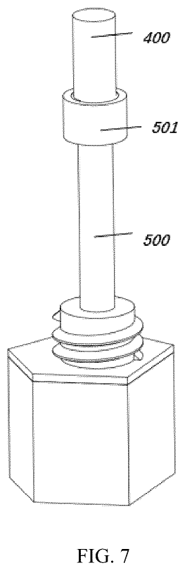

In the existing conventional technology, one end of indicator element is usually inserted into the absorption element (as shown in FIG. 1), so a hole needs to be punched in the absorption element in advance to allow the end of the indicator strip to extend into the hole. This actually has the following disadvantages, the collector 44 shown in FIG. 7 of U.S. Pat. No. 9,414,813B2(in FIG. 1 of the invention) is taken as an example, and a part 56 of the indicator strip 48 is directly located in the absorption element 51, while the other part thereof is located in the channel 54 of the rod-shaped structure 52; and the indicator strip includes the indication areas 48 and 46. The method has the following disadvantages: firstly, generally, the absorption element 51 is used for saliva collection and needs to be chewed in the mouth. If a part of the indicator element is located on the absorption element, some chemicals on the indicator element will flow back to an absorption head in a collection process, which causes pollution and even damages the mouth of a subject. In addition, if the absorption element 51 is still chewed in the mouth after absorbing the liquid sample and softening, the absorption element can be pressed to the end of the indicator strip located in the absorption element, which may damage the indicator strip. The function of chewing is to secrete more saliva to collect more saliva samples. Secondly, such arrangement often cannot fully represent that the absorption element has reached the saturated absorption capacity, because the part of the indicator strip is located on the absorption element, and the liquid is always absorbed by the indicator element first. However, the absorption area around a part of the area 56 where the indicator element is inserted into the absorption element 51 may not necessarily have the liquid sample absorbed. Thirdly, it is necessary to punch the hole in the absorption element 21 in advance, such that the indicator element can be inserted into the hole of the absorption element, and the process is complicated. In addition, if the absorption element is made of soft materials, such as a melamine foam, it is very difficult to punch the hole in the absorption element. Fourthly, the absorption element ultimately needs to be fixedly connected with the rod-shaped structure 52. Generally, the adhesive is applied onto the disc of the rod-shaped structure. If the end of the indicator strip is inserted into an absorber and the adhesive is also applied onto the disc, the operation is inconvenient. Whether the test strip is inserted into the absorption element 51 first or the adhesive is applied onto the surface of the disc first, the operation is not very convenient and the assembling steps are complicated. In addition, if the adhesive is applied onto the disc first, the test strip may also contact with the adhesive, and if the indicator strip is connected with the absorption element first, it is not convenient to apply the adhesive onto the disc.

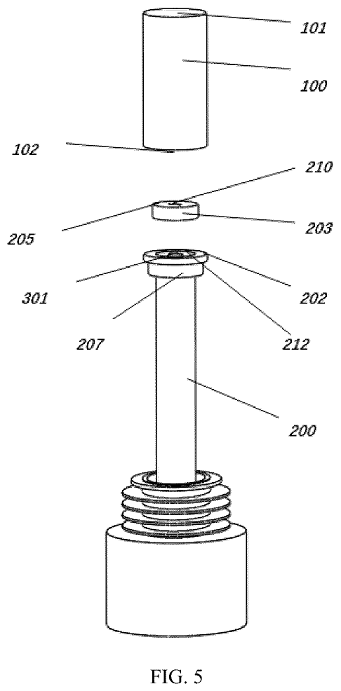

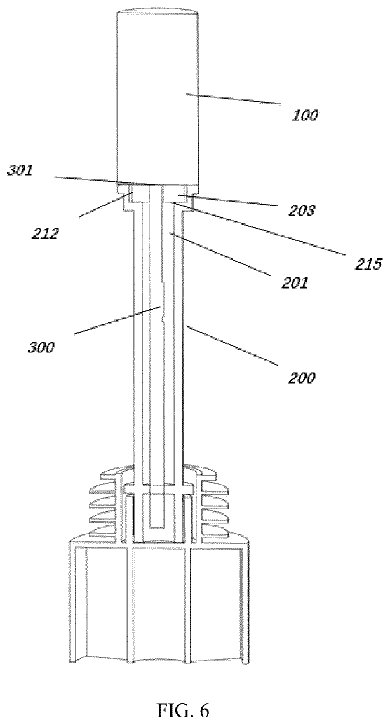

In one embodiment of the invention, as shown in FIG. 5-FIG. 6, the end 102 of the absorption element 100 of the invention is in direct contact with a fixed tray 207, and an elastic tray 203 is provided in the fixed tray and has an opening or a through hole 210; the elastic tray is provided in a recessed area 212 in the center of the fixing tray, and the sunken area 212 is the outlet 215 of the chamber 201 of the rod-shaped structure 200; and when the elastic tray is provided in the recessed area 212, the surface 205 of the elastic tray and an edge surface 202 of the fixed tray are located in a same surface. During the assembly, the testing element or the indicator element passes through or is inserted into the hole 210 of the elastic tray directly, such that an end 301 of the testing element or indicator element 300 is located at or slightly exposed out of the hole 210. If the testing element or the indicator element passes through the hole 210 of the elastic tray, the test strip 300 can be inserted into the hole of the elastic tray alone, one end of the test strip is inserted into the inner chamber 201 of the rod-shaped structure, and then the elastic tray 203 is pressed into the recessed area 212, such that the elastic tray is fixed in the recessed area depending on its elastic force; then, the end 301 of the test strip or indicator strip is pressed, such that the end 301 is slightly exposed out of the hole 210. Alternatively, the elastic tray is fixed in the recessed area 212, and then the testing element or the indicator element is inserted into the through hole, such that the end 301 is slightly exposed from the through hole. After installation, a layer of adhesive can be applied onto the surface 205 of the elastic tray 203, and then the absorption element 102 is allowed to contact with the adhesive layer. Generally, the end 102 of the absorption element 100 needs to be pressed on the fixed tray with a force. In a pressing process, the adhesive in advance applied onto the surface 205 of the elastic tray 203 extends to the area of the edge surface 202 of the fixed tray, such that the absorption element can be fixed onto the fixed tray 207. Herein, the material of the absorption element 100 is generally rigid or hard, such that it can be pressed by applying pressure and the absorption element 100 can be adhered to the fixed tray 207 by the adhesive. For example, these hard absorbent materials 207 are generally polypropylene sponge (PP), polyvinyl alcohol sponge (PVA), polypropylene, and other materials. These materials are hard materials when dry, and they soften when absorbing the liquid. Therefore, in an assembling process, the absorption element is relatively rigid, such that the absorption element 100 can be bonded to the surface 202 of the fixing tray 207 by applying pressure. Through the separate elastic tray 203, the assembling process and steps are simplified, the step of adhesive application is separated from the step of inserting the test strip, and the end of the testing element may be not inserted into the absorption element 100, thus overcoming the defects of the conventional prior art.

In some embodiments, although in examples as shown in FIG. 5-FIG. 6, the structure has been improved as compared to the prior art and this brings convenience and simplicity in both the assembly step and the adhesive application, there is still a defect that when the adhesive is applied to the surface 205 of the elastic tray 203, the adhesive easily flows into the hole 210 to seal the hole 210 and some of the adhesive flows into the chamber 201 along the hole 210. Once the adhesive changes from liquid to solid, it actually acts as a barrier to hinder flowing of the liquid between the end 102 of the absorption element 100 and the end 301 of the test strip or indicator strip. Even if the end of the indicator strip 300 is slightly exposed from the hole 210 for a little length, such as several millimeters; when applied onto the surface 205 of the elastic tray, the adhesive may also be accidentally applied into the hole 210; or when the end 102 of the absorption element 100 is in contact with and presses against the surface 205 of the elastic tray, the adhesive is in a liquid state and has fluidity in a squeezing process, such that the end 301 of the test strip will also shrink into the hole 210 (at least located below the hole 210), and the adhesive will also form a thin glue layer at the hole. After the adhesive is naturally dried, the thin adhesive layer (non-absorbent) hinders flowing of the liquid between the absorption element and the end 301 of the indicator strip, so the liquid on the absorption element 100 cannot flow into the indicator strip 300, and the indication of whether the liquid sample is sufficient or not cannot be realized. After all, in such a small area, for example, when the adhesive is applied to the surface of the elastic tray 203 with a size of 0.3-1 cm², the precision requirement is very high and the adhesive is applied by hand, so it is more difficult to control adhesive application, and the aqueous adhesive flows into the hole 210 so as to block it.

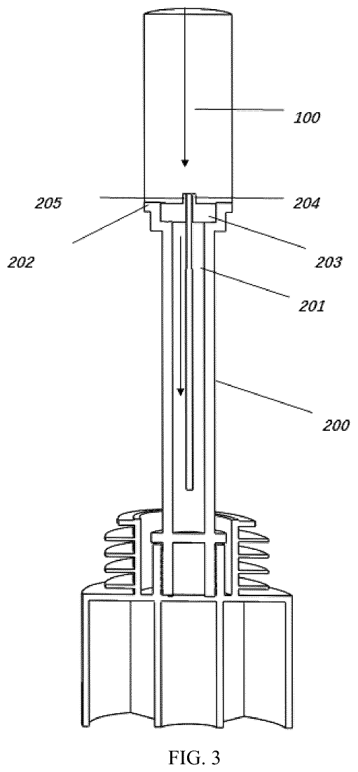

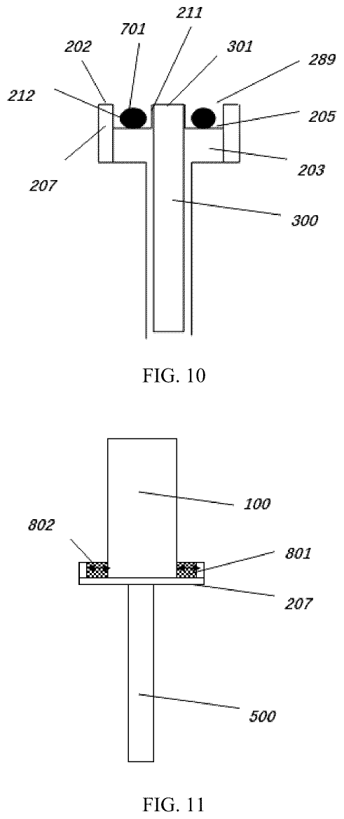

Therefore, in the specific embodiments shown in FIG. 2-FIG. 4 and FIG. 10, a protruding pipe 211 is provided on the hole 210 of the elastic tray, that is, a pipe-like structure extends outward from the hole 210, the pipe is higher than a surface of the elastic tray 203, for example, 1-5 mm high, or higher than the thickness of the adhesive applied to the surface 205, for example, 1, 2, 3, 4, 5 mm high. The adhesive will not overflow to a pipe opening 204 when applied to the surface 205 of the elastic tray 203, such that one end 301 of the indicator element inserted from the opening 204 cannot be in contact with the adhesive, and the adhesive will naturally not seal the opening 204. When the end 102 of the absorption element 100 is pressed against the surface 205 of the elastic tray 203, the adhesive layer applied around the surface 205 of the pipe will make the absorption element and the elastic tray to bonded together. Although there is the protruding pipe 211, the absorption element 100 is rigid and the protruding pipe 211 will not affect adhesion between the absorption element 100 and the elastic tray. In some embodiments, the elastic tray 203 is still provided in the recessed area 212 of the fixed tray 207, the surface 205 of the elastic tray and the surface 202 of the fixed tray (as shown in FIG. 3) are located in a same surface, and then the pipe 211 protrudes upward from the surface 205 of the elastic tray and the surface 202 of the fixed tray 207. As shown in FIG. 10, in an optional embodiment, the recessed area 212 of the fixed tray 207 can be made deeper; and when the elastic tray 203 is fixed in the recessed area, the opening 204 of the pipe 211 and the surface 205 of the fixed tray 207 are located at a same horizontal position, for example, the pipe is 2 mm higher than the surface 205 of the elastic tray 203; in this manner, a depression 289 with a depth of 2 mm is formed in the recessed area of the fixed tray; during the adhesive application, one drop or two drops of the adhesive 701 are directly dropped in the depression. In this case, if the squeezed thickness of the adhesive is substantially 1.5-2 mm, the end 102 of the absorption element can be in direct contact with the elastic tray 203. As explained above, although the absorption element is rigid, this does not mean that the absorption element is completely absent from being deformable or compressible; especially when the absorption element is made of materials such as polypropylene sponge (PP), polyvinyl alcohol sponge (PVA), polypropylene, and the like, these materials can still have a little elasticity even when they are dry, so the absorption element being compressed by 1-2 mm can still be tolerable. Thus, when the end 102 of the absorption element is released from the elastic tray 203 and the surface 202 of the fixed tray 207, the adhesive has a thin layer of about 1-1.5, and the protruding pipe 211 can slightly enter into the absorption element, such that other areas of the end 102 of the absorption element 100 can be in contact with the adhesive and bonded to the fixed tray 207. In addition, because the protruding pipe 211 slightly enters into the absorption element, the end 301 of the indicator strip 300 is in close contact with the end 102 of the absorption element 100. In order to make the absorption element more accurately bonded to the fixing disk 207 by the adhesive, a rough surface can be formed on the surface 205 of the elastic tray, and of course, the rough surface can also be formed on a part of the surface 202 of the fixed tray, such that the absorption element can be more firmly fixed to the fixed tray 207.

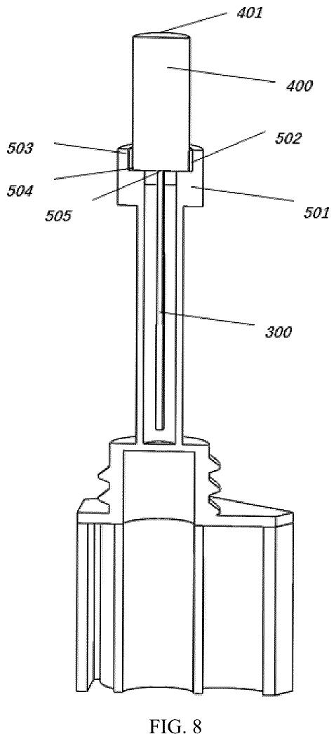

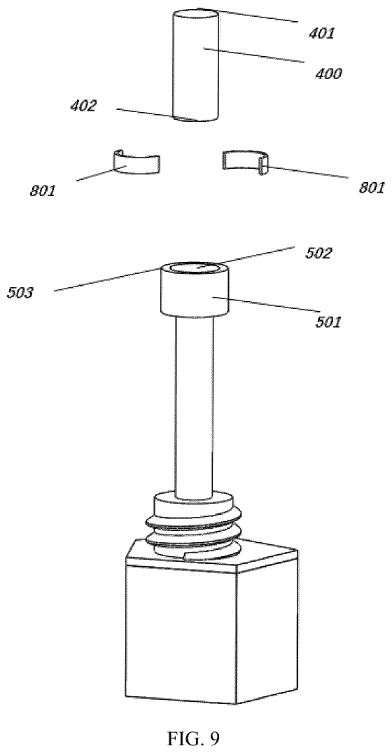

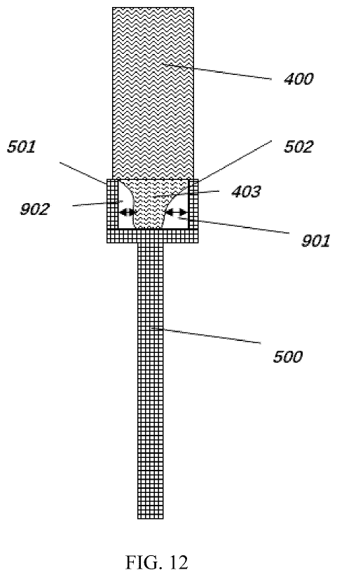

In the above embodiments, for those cases where the absorption element is made of a material that is hard when dry and softens when absorbing water, the absorption element can be bonded by the adhesive. However, no matter what the material is dry or absorbs water, the material is soft but rarely hardened, so it is difficult to bond the absorption element by the adhesive, for example, a melamine foam and a sponge. Therefore, as shown in FIG. 8-FIG. 9, FIG. 11 and FIG. 12, in some embodiments, the invention provides a collector; the collector is provided with one chamber 501 having a hollow chamber 502; the hollow chamber is surrounded by a bottom 504 and a side wall 503; one absorption element 400 is provided in the space and partially located in the hollow chamber 502; one elastic fixing element 801 is further provided in the space; a side of the elastic fixing element is in contact with the surface of the absorption element while the other side thereof is in contact with the inner surface of the side wall 503; and the absorption element is fixed in the chamber depending on the elastic force of the elastic fixing element. The elastic element can be of any shape. The chamber may be provided on the fixed tray 207, and of course, in some embodiments, the bottom of the chamber 504 may be connected with one rod-shaped structure 500 with a channel 501, and the channel 501 is in communication with the chamber; and if the indicator strip 300 is provided in the channel 501, the end 301 of the indicator strip is in contact with one end 402 of the absorption element. The elastic fixing element is adopted because it can be compressed and has the natural property of resilience, or the elastic fixing element has the ability to be compressed after receiving an external force and the ability to return to its original location after the external force disappears; therefore, during the assembly, the absorption element can be located in the chamber 502, there is a gap between the absorption element and the chamber, and then the elastic element can be plugged into the gap; generally, the width of the elastic fixing element is larger than the width of the gap, it is inevitable that the elastic fixing element is compressed when plugged; therefore, after the elastic fixing element is compressed to release to an external force, it can exert an acting force between the absorption element and the inner surface of the side wall 503 of the chamber 501, such that the absorption element is fixed in the chamber. In some embodiments, a pair of elastic fixing elements 901, 902 is provided and respectively located on both sides of the absorption element. The absorption element is soft, for example, the melamine foam; and the materials described in Patent Application No. CA3167464 are incorporated by reference in their entirety as part of this application. In a case that the absorption element 400 is pressed by the two elastic fixing elements in a direction of relative forces, the absorption element 400 will shrink at a squeezing location 403 (as shown in FIG. 12, in this case, the absorption element does not absorb the liquid and is kept dry), but the elastic fixing element also needs to be plugged into the chamber 502. Therefore, the absorption element 400 is fixed into the chamber 502 still depending on the interaction force of the elastic fixing element (with a compression force towards the absorption element, as shown by an arrow), such that the absorption element is fixed onto the collector, and in this manner, the step of adhesive application is omitted.

Of course, if the absorption element is made of the material that is rigid when dry, and softens after being wet, it is also possible to fix the absorption element with the elastic fixing elements. For example, as shown in FIG. 11, the absorption element 400 is fixed in the chamber by the two elastic fixing elements 801, 802 that are plugged in the chamber 501, and in this case, the dry hard absorption element can be fixed in such a way; after the absorption element softens after absorbing the liquid, the elastic fixing elements originally have the force to return to the center (when the absorption element is dry, and the elastic fixing elements are not fully recovered to a normal state); therefore, when the absorption element softens, the two elastic fixing elements continue to have the ability to squeeze the absorption element, such that a part of the absorption element is shrunk (as illustrated in FIG. 11), and the absorption element can still be fixed in the chamber |501 without falling off.

Herein, the elastic fixing elements may be a spring, a silicone plug, a rubber plug, and other similar materials, may be not compressed, and can be restored to the normal state when the external force disappears, and has an acting force when they cannot be restored to the normal state. In the invention, the acting force is used to fix the absorption element onto the collector, which reduces the steps of adhesive application and saves the cost. These materials can also be used as the elastic tray or the elastic fixing block.

### Analyte

Examples that can use an analyte related to the invention include some small-molecule substances, including drugs (such as drug of abuse). “Drug of Abuse” (DOA) refers to the use of a drug (typically functions to paralyze the nerves) not directed to a medical purpose. Abuse of these drugs will lead to physical and mental damage, dependency, addiction and/or death. Examples of drug abuse include cocaine; amphetamine (AMP) (e.g., Black Beauty, white amphetamine tablets, dexamphetamine, dexamphetamine tablets, and Beans); methamphetamine (MET) (crank, meth, crystal and speed); barbiturate (BAR) (such as Valium, Roche Pharmaceuticals, Nutley, and New Jersey); sedatives (i.e., a sleep aid medicine); lysergic acid diethylamine (LSD); inhibitors (downers, goofballs, barbs, blue devils, yellow jackets, and methaqualone); tricyclic antidepressants (TCAs, i.e. imipramine, amitriptyline, and doxepin); dimethylenedioxymethylaniline (MDMA); phencyclidine (PCP); tetrahydrocannabinol (THC, pot, dope, hash, weed, etc.); opiates (i.e., morphine (MOP) or opium, cocaine (COC), heroin, and hydroxydihydrocodeinone); and anxiolytic drugs and sedative-hypnotic drugs. The anxiolytic drugs are mainly used for relieving anxiety, tension, and fear, and stabilizing emotion, and have hypnotic and sedative effects. The anxiolytic drugs include benzodiazepines (BZO), atypical benzodiazepines (BZ), fused dinitrogen NB23C, benzodiazepines, ligands of BZ receptors, open-ring BZ, diphenylmethane derivatives, piperazine carboxylates, piperidine carboxylates, quinazolinones, thiazine and thiazole derivatives, other heterocycles, imidazole-type sedative/analgesic drugs (e.g., oxycodone (OXY) and methadone (MTD)), propylene glycol derivatives-carbamates, aliphatic compounds, anthracene derivatives, and the like. The test device of the invention may also be used for detecting drugs belonging to a medical use but easy to be taken excessively, such as tricyclic antidepressants (imipramine or analogues) and acetaminophen. These drugs are metabolized into micromolecular substances after absorbed by human body. These micromolecular substances exist in blood, urine, saliva, sweat and other body fluids or in some body fluids.

For example, the analyte detected by the invention includes but is not limited to creatinine, bilirubin, nitrite, (nonspecific) proteins, hormones (for example, human chorionic gonadotropin, progesterone, follicle-stimulating hormone, etc.), blood, leucocytes, sugar, heavy metals or toxins, bacterial substances (such as proteins or carbohydrates against specific bacteria, for example, Escherichia coli 0157: H7, Staphylococcus, Salmonella, Fusiformis, Camyplobacter genus, L. monocytogenes, Vibrio, or Bacillus cereus) and substances related with physiological features in a urine sample, such as pH and specific gravity. Chemical analysis of any other clinical urine may be performed by lateral flow detection in combination with the device of the invention. An appropriate testing element according to the invention can be used to detect any analyte. Preferably, the testing device of the invention is used to detect small drug molecules in saliva and urine. Preferably, the testing device can be used to detect small molecular substances such as viruses and bacteria in saliva, throat or nasal fluid. The testing device can also be used to detect white blood cells, red blood cells, urobilinogen, urine vitamin c, urine crystals, urine specific gravity, urine albumin, urine acetone bodies, urine colony count, urine pH and nitrous acid in the liquid samples. For example, the testing device can also be used to detect the levels of white blood cells, red blood cells, urobilinogen, urine vitamin c, urine crystals, urine specific gravity, urine albumin, urine acetone bodies, urine colony count, urine pH and nitrous acid.

The analyte in the urine can be tested by an immune method or a chemical method. Testing by the chemical method means that the absorbent material is treated with chemical substances. When the urine contains a specified amount of a specific analyte, a chemical reaction will occur on the absorbent material, and colored substances are produced and make the absorbent material colored. Through comparison of the colored substances and a standard colorimetric card, it is possible to know whether the analyte in the urine exists or how much it probably exists. Generally, the thick color indicates the high content of the analyte. For example, when the nitrous acid is tested, aromatic sulfadiazine is treated on the testing area and reacts with the nitrous acid to generate a diazo compound; the diazo compound reacts with 2,3,4-tetrahydrobenzo (h) quinoline-3-phenol to generate a pink color substance; and the pink color substance precipitates on the testing area, such that the testing area shows pink. The white blood cells in urine contain esterase that can catalyze the hydrolysis of privatized pyrrole amino acid ester to release 3-hydroxy-5-phenylpyrrole. Then, the pyrrole reacts with diazonium salt to form purple. The reaction is used to test the content or number of the white blood cells in urine.

All the patents and publications mentioned in the description of the invention indicate that these are public technologies in the art and can be used by the invention. All the patents and publications cited herein are listed in the references, just as each publication is specifically referenced separately. The invention described herein can be realized in the absence of any one element or multiple elements, one restriction or multiple restrictions, where such restriction is not specifically described here. For example, the terms “comprising”, “essentially consisting of” and “consisting of” in each example herein may be replaced by the rest 2 terms. The terms and expressions which have been employed herein are descriptive rather than restrictive, and there is no intention to suggest that these terms and expressions in this description exclude any equivalents, but it is to be understood that any appropriate changes or modifications can be made within the scope of the invention and appended claims.

1. A collector for a liquid sample, comprising:
an absorption element for absorbing the liquid sample; and a fixed tray for fixing the absorption element, wherein the fixed tray is connected with a rod comprising a channel, the channel is used for accommodating an indicator strip that indicates presence or absence of a sufficient liquid or a testing element for testing an analyte in the liquid sample, the channel comprises an outlet, and the outlet is in fluid communication with the fixed tray.

2. The collector according to claim 1, wherein an elastic sheet is fixed onto the fixed tray; the elastic sheet is provided with the outlet thereon; and when the absorption element is fixed onto the fixed tray, one end of the absorption element is in contact with the elastic sheet.

3. The collector according to claim 2, wherein an adhesive layer is provided between a surface of the elastic sheet and the end of the absorption element, and the absorption element and the fixed tray are bonded together by the adhesive layer.

4. The collector according to claim 3, wherein when a hollow rod comprises the indicator strip or the testing element, one end of the indicator strip or one end of the test strip is in contact with the end of the absorption element through the outlet.

5. The collector according to claim 4, wherein the outlet of the elastic sheet extends outwards to form a pipe, and the indicator strip is in contact with the end of the absorption element through an outlet of the pipe.

6. The collector according to claim 5, wherein the adhesive is applied onto the surface of the elastic sheet around the pipe without sealing the outlet of the elastic sheet.

7. The collector according to claim 1, wherein the fixed tray is provided with a chamber with a bottom and a side wall; an opening of the channel is provided on the bottom of the chamber; one end of the absorption element is located in the chamber; and an elastic fixing element is provided around the absorption element, such that the absorption element is fixed in the chamber through the elastic fixing element.

8. The collector according to claim 7, wherein the elastic fixing element is provided in two; and the elastic fixing element is provided around the absorption element, such that the absorption element is fixed in the chamber.

9. The collector according to claim 8, wherein the absorption element is a cylinder; the elastic fixing element is made of annular rubber or latex; and the absorption element is fixed in the chamber on the fixed tray through an interaction force of the annular rubber or latex with the absorption element and an inner surface of the side wall.

10. The collector according to claim 9, wherein the indicator strip is provided in the channel of the rod, and one end of the indicator strip is in contact with the end of the absorption element.

11. The collector according to claim 1, wherein the liquid sample is saliva, urine, sputum, or a nasal secretion liquid.

12. The collector according to claim 1, wherein the absorption element comprises polyester, a sponge, cotton, and a filter paper.

13. The collector according to claim 1, wherein the absorption element is rigid when dry, without substantively deforming through compression, and the absorption element deforms through compression when wet.

14. The collector according to claim 1, wherein the absorption element is in a soft and compressible state when dry and absorbing the liquid.

15. The collector according to claim 1, wherein the absorption element consists of a polypropylene sponge (PP), a polyvinyl alcohol sponge (PVA), and a polypropylene or melamine foam.
